(19) United States
(12) Patent Application Publication
(10) Pub. No.: US 2011/0317248 A1
(43) Pub. Date: Dec. 29, 2011

(54) Electronic paper display device and manufacturing method thereof

(75) Inventors: Young Woo Lee, Suwon-si (KR); Choong Hee Lee, Suwon-si (KR); Hwan Soo Lee, Suwon-si (KR); Sang Moon Lee, Seoul (KR)

(73) Assignee: SAMSUNG ELECTRO-MECHANICS CO., LTD., Suwon (KR)

(21) Appl. No.: 12/926,216

(22) Filed: Nov. 2, 2010

(30) Foreign Application Priority Data
Jun. 24, 2010 (KR) 10-2010-0060075

(51) Int. Cl. G02B 26/02; H01J 9/00

(52) U.S. Cl. 359/296; 445/24

(57) ABSTRACT

Disclosed herein are an electronic paper display device, including: a first electrode; a barrier rib layer disposed on the first electrode and defining a plurality of cell regions; a second electrode facing the first electrode and disposed on the barrier rib layer; a twist ball floated in a dielectric solution filled in each cell region and driven according to electric field applied to the first and second electrodes; and an enlarging member disposed on any one of the top surface and the bottom surface of the second electrode and visually enlarging the size of the twist ball, and a manufacturing method thereof.

### CROSS REFERENCE TO RELATED APPLICATION

This application claims the benefit of Korean Patent Application No. 10-2010-0060075, filed on Jun. 24, 2010, entitled “Electronic Paper Display Device and Manufacturing Method Thereof,” which is hereby incorporated by reference in its entirety into this application.

### BACKGROUND OF THE INVENTION

1. Technical Field

The present invention relates to an electronic paper display device and a manufacturing method thereof, and more particularly, to an electronic paper display device having an enlarging member visually enlarging a size of a twist ball and a manufacturing method thereof.

2. Description of the Related Art

As a next-generation display device, a liquid crystal display (LCD), a plasma display panel (PDP), an organic electroluminescent device, an electronic paper display device, or the like, has been prevalently propagated.

Among others, the electronic paper display device can be flexibly bent and is inexpensive in production cost, as compared to other display devices.

In addition, since the electronic paper display device does not require background lighting or a continuous recharging, it can be driven with very small energy, such that it has characteristics such as very excellent energy efficiency.

Further, since the electronic paper display device may have characteristics of high definition and wide viewing angle and also include a memory function by which displayed characters or images do not completely disappear even when the supply of power is instantly interrupted, it is expected that the electronic paper display device will be widely used in various fields such as a foldable screen, an electronic wallpaper, or the like, in addition to printing media such as books, newspapers, or magazines, etc.

Meanwhile, as a method of implementing the electronic paper display device, there are largely a method of using a liquid crystal, an organic EL method, a reflecting film reflective display method, an electrophoresis method, a twist ball method, an electro chromic method, a mechanical reflective display method, or the like.

Among others, the electronic paper display device using the twist ball includes two electrodes and a twist ball interposed between the two electrodes, the twist ball having optical and electrical anisotropy. Herein, a peripheral space is formed around the twist ball and a dielectric solution is filled in the peripheral space. In this case, the twist ball floats in the dielectric solution.

The twist ball may be configured to include a black hemisphere and a white hemisphere charged with different charges. The electronic paper display device using the twist ball rotates each hemisphere of particles to face electrode surfaces having opposite polarity to each other within the dielectric solution filled in the peripheral space according to the direction of the applied voltage when voltage is applied to two electrodes, thereby displaying white and black.

In this configuration, the peripheral space of the twist ball should be formed to be larger than the twist ball, such that the twist ball is rotated. In this case, the peripheral space of the twist ball is a dead zone in which images are not displayed. The dead zone is a factor to deteriorate the contrast ratio and reflectivity of the electronic paper.

Therefore, the related art has a problem in that the electronic paper display device using the twist ball deteriorates the contrast ratio and reflectivity of the electronic paper due to the peripheral space to rotate the twist ball.

### SUMMARY OF THE INVENTION

An object of the present invention is to provide an electronic paper display device having an enlarging member visually enlarging a size of a twist ball to fill a dead zone with an image of a twist ball to improve the contrast ratio and reflectivity of the electronic paper display device and a manufacturing method thereof.

According to an exemplary embodiment of the present invention, there is provided an electronic paper display device, including: a first electrode; a barrier rib layer disposed on the first electrode and defining a plurality of cell regions; a second electrode facing the first electrode and disposed on the barrier rib layer; twist balls floated in a dielectric solution filled in each cell region and driven according to electric field applied to the first and second electrodes; and an enlarging member disposed on any one of the top surface and the bottom surface of the second electrode and visually enlarging the size of the twist ball.

The enlarging member may include any one of a convex lens and a prism lens.

The enlarging member may include a transparent film including a convex portion corresponding to the cell region.

The convex portion may be formed by a polymer gel of which volume is expanded upward due to the dielectric solution highly filled in the cell region or the impregnation of the dielectric solution.

The second electrode may include a convex portion corresponding to the convex portion.

The second electrode may be disposed on the lower part of the transparent film.

The electronic paper display device may further include an adhesive member interposed between the second electrode and the enlarging member.

The second electrode may be integrally formed with the transparent film.

According to an exemplary embodiment of the present invention, there is provided a method for manufacturing an electronic paper display device, including: forming a barrier rib layer defining a plurality of cell regions on a first electrode; injecting a twist ball into the first electrode in each cell region; forming a second electrode on the barrier rib layer including the twist ball; injecting a dielectric solution into each cell around the twist ball; and forming enlarging member visually enlarging the twist ball on the second electrode.

The enlarging member may include any one of a convex lens and a prism lens.

The forming the enlarging member may include: performing hydrophobic surface treatment on the second electrode corresponding to the periphery of the cell region; applying hydrophilic resin composition to the second electrode; and curing the applied hydrophilic composition after the applied hydrophilic resin composition is naturally convexly deformed.

The forming the enlarging member may further include: applying an adhesive to the second electrode; and attaching an enlarging member sheet to the second electrode by using the adhesive.

The enlarging member may be formed by any one of a printing method and an imprinting method.

According to an exemplary embodiment of the present invention, there is provided a method for manufacturing an electronic paper display device, including: forming a barrier rib layer defining a plurality of cell regions on a first electrode: injecting a twist ball into the first electrode in each cell region; forming a transparent film and a second electrode on the barrier rib layer including the twist ball; and forming a convex portion visually enlarging the twist ball corresponding to each cell region in the transparent film by overfilling a dielectric solution in each cell around the twist ball.

The second electrode may be disposed on the lower part of the transparent film to form a convex portion corresponding to the convex portion in the second electrode.

The transparent film may be integrally formed with the second electrode.

The second electrode may be attached to the transparent film by an adhesive member.

The second electrode may be formed of a conductive substrate.

The method for manufacturing an electronic paper display device may further include forming a base layer on the second electrode.

According to an exemplary embodiment of the present invention, there is provided a method for manufacturing an electronic paper display device, including: forming a barrier rib layer defining a plurality of cell regions-on a first electrode; injecting a twist ball into the first electrode in each cell region; filling a polymer gel in a cell region of the barrier rib layer including the twist ball; forming a transparent film and a second electrode on the barrier rib layer including the polymer gel; and forming a convex portion visually enlarging the twist ball corresponding to each cell region in the transparent film due to the expansion of the polymer gel by filling a dielectric solution in each cell region around the twist ball.

The second electrode may be disposed on the lower part of the transparent film to form a convex portion corresponding to the convex portion in the second electrode.

The transparent film may be integrally formed with the second electrode.

The second electrode may be attached by an adhesive member formed on the transparent film.

The second electrode may be formed of a conductive substrate.

The method for manufacturing an electronic paper display device may further include forming a base layer on the second electrode.

### BRIEF DESCRIPTION OF THE DRAWINGS

FIG. 1 is a cross-sectional view of an electronic paper display device according to a first exemplary embodiment of the present invention;

FIGS. 2 and 3 are cross-sectional views of an electronic paper display device shown for explaining examples of other types of an enlarging member included in an electronic paper display device according to a first exemplary embodiment of the present invention;

FIG. 4 is a cross-sectional view of an electronic paper display device according to a second exemplary embodiment of the present invention;

FIG. 5 is a cross-sectional view of an electronic paper display device shown for explaining an example of other types of a second electrode included in an electronic paper display device according to a second exemplary embodiment of the present invention;

FIG. 6 is a cross-sectional view of an electronic paper display device according to a third exemplary embodiment of the present invention;

FIGS. 7 to 11 are cross-sectional views for explaining a method for manufacturing an electronic paper display device according to a fourth exemplary embodiment of the present invention;

FIGS. 12 to 14 are cross-sectional views for explaining a method for manufacturing an electronic paper display device according to a fifth exemplary embodiment of the present invention; and

FIGS. 15 to 17 are cross-sectional views for explaining a method for manufacturing an electronic paper display device according to a sixth exemplary embodiment of the present invention.

### DESCRIPTION OF THE PREFERRED EMBODIMENTS

Hereinafter, an electronic paper display device according to embodiments of the present invention will be described in detail with reference to some of the accompanying drawings. The exemplary embodiments of the present invention to be described below are provided by way of example so that the idea of the present invention can be sufficiently transferred to those skilled in the art to which the present invention pertains.

Therefore, the present invention may be modified in many different forms and it should not be limited to the embodiments set forth herein. In the drawings, the size, and the thickness of the device may be exaggerated for convenience. Like reference numerals denote like elements throughout the specification.

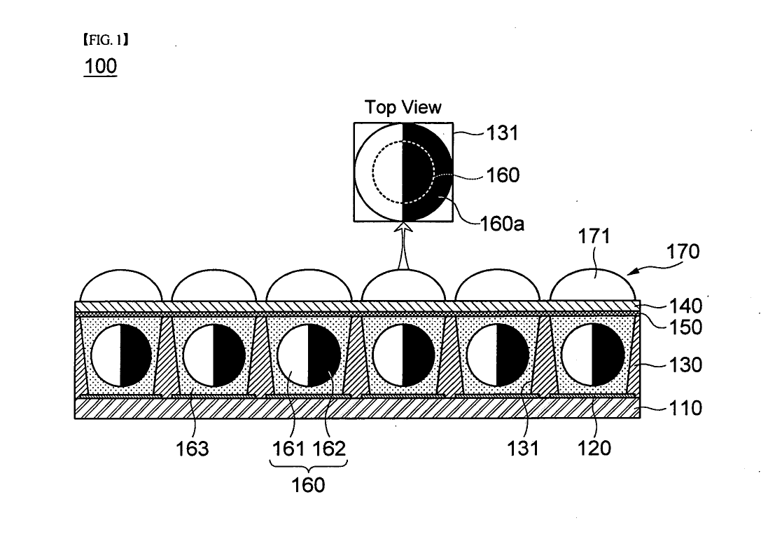

FIG. 1 is a cross-sectional view of an electronic paper display device according to a first exemplary embodiment of the present invention.

Referring to FIG. 1, an electronic paper display device 100 according to a first exemplary embodiment of the present invention may include a first electrode 120, a barrier rib layer 130, a second electrode 150, a twist ball 160, and an enlarging member 170.

In this case, the first electrode 120 may be disposed on a first base layer 110.

The first base layer 110 may serve to support the first electrode 120 and the electronic paper display device 100. As an example of a material forming the first base layer 110, there may be a plastic substrate, a glass substrate, etc., or a film type.

The first electrode 120 may be formed of a conductive layer. In this case, a conductive material forming the first electrode 120 may include, for example, Cu, Ag, or the like. In addition, the first electrode 120 may be formed of a plurality of conductive patterns. Therefore, the plurality of conductive patterns can individually apply voltage, thereby making it possible to drive a twist ball 160 for each region to form the conductive patterns.

The barrier rib layer 130 is disposed on the first electrode 120 to define a plurality of cell regions 131. In this configuration, the first electrode 120 corresponding to each cell region 131 may be exposed from the barrier rib layer 130.

The barrier rib layer 130 may be made of a thermosetting resin or a UV curable resin. For example, the barrier rib layer 130 may be made of polyurethane acrylate (PUA) or polydimethylsiloxane (PDMS), but in the exemplary embodiment of the present invention, the material of the barrier rib layer 130 is not limited thereto.

The second electrode 150 may be disposed on the barrier rib layer 130. In this case, when the first electrode 120 may be made of a conductive material reflecting light, the second electrode 150 may be made of a conductive material capable of transmitting light, for example, ITO, IZO, ITZO, or the like.

The second electrode 150 may be formed of a conductive layer or a conductive substrate.

In this case, when the second electrode 150 is formed of a conductive layer, a second base layer 140 may be further provided on the second electrode 150 in order to support the second electrode 150. In this configuration, the second base layer 140 may be a substrate type or a film type. In addition, the second base layer 140 may be made of a transparent material that can transmit light. For example, the second base layer 140 may include polyethylene terephthalate (PET), polyvinyl alcohol (PVA), polyethylene (PE), polycarbonate (PC), polyacrylate, polymethylacrylate, polyurethane, cellulose acetate butylate (CAB), or the like.

Alternatively, when the second electrode 150 is a conductive substrate type, the second electrode 150 may not need a separate second base layer. In other words, the second electrode 150 may serve as an electrode and a base layer. In this case, the conductive substrate may be made of a conductive polymer, a metal, and a resin containing a conductive powder.

The twist ball 160 may be interposed between the first and second electrodes 120 and 150 in each cell region 131. In this case, the twist ball 160 may be uniformly arranged by the cell region 131 defined by the barrier rib layer 130, thereby making it possible to improve the contrast ratio and prevent the image quality from being deteriorated.

The twist ball 160 may be a twist ball configured to include a first hemisphere 161 reflecting light and a second hemisphere 162 absorbing light. The first hemisphere 161 and the second hemisphere 162 may be charged with different charges. In this case, a dielectric solution 163 is filled in each cell region 131 and the twist ball 160 may float within the dielectric solution 163. In this configuration, the twist ball 160 rotates by electric field applied to the inside of each cell region 131 by using the dielectric solution 163 as a medium, thereby making it possible to display images. That is, the twist ball 160 can display images according to electric field applied to the first and second electrodes 120 and 150.

In this case, a liquid-phase material performing liquid-phase photo conversion and having lubricant component, for example, Dow corning 10, Centistoke 200, or the like, may be used as the dielectric solution 163. However, in the embodiment of the present invention, the material of the dielectric solution 163 is not limited thereto.

In addition, although not shown, the first electrode 120 and the second electrode 150 seals the twist ball 160 and are bonded to each other by an adhesive material interposed between the barrier rib layer 130 and the second electrode 150. In this case, as the adhesive material, a resin having adhesion, for example, an UV curable resin may be used.

The enlarging member 170 may be disposed on the second electrode 150. In this case, when the second base layer 140 is provided on the second electrode 150, the enlarging member 170 may be disposed on the second base layer 140.

The enlarging member 170 may include a convex lens 171 disposed to correspond to each cell region 131. In this case, since the enlarging member 170 can visually enlarge the twist ball 160 injected into the cell region, it may be considered that an image 160a of the twist ball is completely filled in the cell region 131, from a user's viewpoint. Therefore, since peripheral space to rotate the twist ball 160, that is, the dead zone is visually reduced, the contrast ratio and reflectivity of the electronic paper display device 100 can be simultaneously improved. As a result, the overall image quality characteristics of the electronic paper display device 100 can be improved due to the improvement of contrast ratio and reflectivity of the electronic paper display device 100.

The enlarging member 170 may be made of glass or transparent resin as a light transmitting material. In this case, an example of the transparent resin may include any one material or two or more mixing materials of silicon-based resin, acrylate-based resin, polyimide, polycarbonate, polyester, polystylene, polymethylacrylate, polyethylene, polypropylene, polyvinylchloride, norbornene resin, polystyrene-based resin, polyethylene naphthalate, polyarylate, polyether sulfone, polyetherimide, and modified resin thereof. However, in the embodiment of the present invention, the material of the enlarging member is not limited thereto.

In addition, although not shown, the enlarging member 170 may be fixed by an adhesive layer coated on the second electrode 150 or the second base layer 140. In this configuration, the adhesive layer may include transparent adhesive resin, for example, at least one of silicon resin, acryl-based resin, and epoxy-based resin.

Therefore, as in the exemplary embodiment of the present invention, since the dead zone to rotate the twist ball may look like reducing by visually enlarging the twist ball using the enlarging member, it can be expected that the contrast ratio and reflectivity of the electronic paper display device are improved. In addition, it can be expected that the overall image quality characteristics of the electronic paper display device is improved.

Further, the exemplary embodiment of the present invention describes the enlarging member 170 of the type of the convex lens 171 but is not limited thereto.

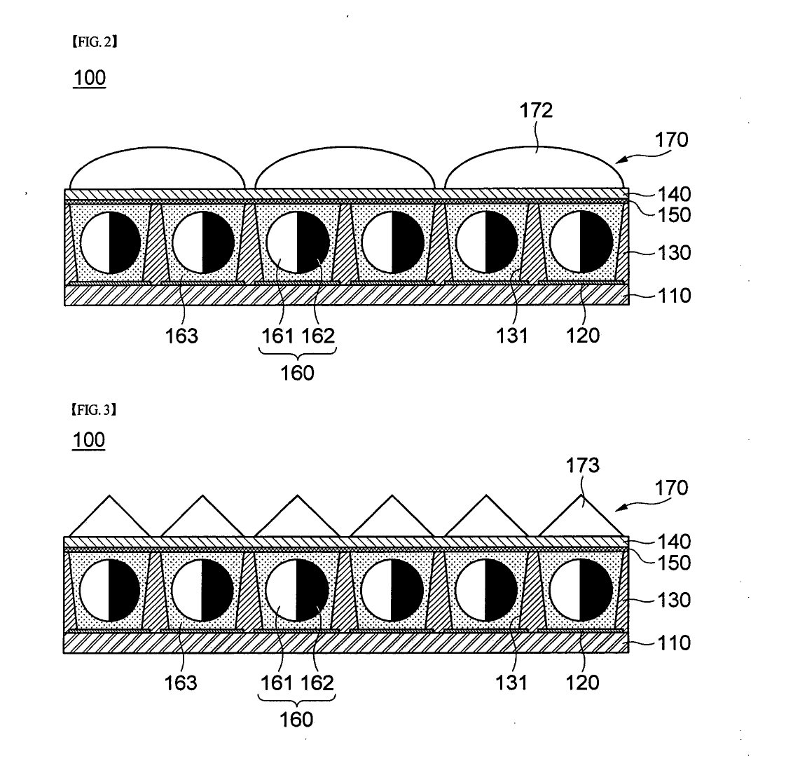

Hereinafter, examples of other types of the enlarging member included in the electronic paper display device according to the first embodiment of the present invention will be described with reference to FIGS. 2 to 3. In this case, the electronic paper display device has the same technical components as the above-mentioned electronic paper display device except for the type of the enlarging member and therefore, the description thereof is not repeated. Like components are denoted by like reference numerals.

FIGS. 2 and 3 are cross-sectional views of an electronic paper display device shown for explaining examples of other types of the enlarging member 170 included in the electronic paper display device according to the first exemplary embodiment of the present invention.

As shown in FIG. 2, the enlarging member 170 may include the convex lens 172 corresponding to at least two cell regions. In other words, at least two twist balls 160 can be visually enlarged by one convex lens 172.

Alternatively, as shown in FIG. 3, the enlarging member 170 may include the prism lens 173 corresponding to each cell region 131. The prism lens 173 can visually enlarge the twist ball 160 corresponding to each cell region 131. In this case, the prism lens 173 is formed to correspond to one cell region 131, but is not limited thereto. The prism lens 173 may be formed to correspond to at least two cell regions 131.

FIG. 4 is a cross-sectional view of an electronic paper display device according to a second exemplary embodiment of the present invention.

In this case, the electronic paper display device has the same technical components as the electronic paper display device according to the first exemplary embodiment except for the configuration of the enlarging member and therefore, the description thereof is not repeated. Like components are denoted by like reference numerals.

Referring to FIG. 4, the electronic paper display device 100 according to the second exemplary embodiment of the present invention may include the first electrode 120, the barrier rib layer 130 defining a plurality of cell regions 131 on the first electrode 120, the second electrode 150 disposed on the barrier rib layer 130, facing the first electrode 120, the twist ball 160 floating in the dielectric solution 163 filled in each cell region 131 and displaying images according to electric field applied to the first and second electrodes 120 and 150, and an enlarging member 270 visually enlarging the size of the twist ball 160.

In this configuration, the enlarging member 270 may include a transparent film 271 including a convex portion 272 convexly protruded upward by the dielectric solution 163 overfilled in the cell region 131.

The transparent film 271 may be made of a flexible material that can be convexly deformed due to the overfilling of the dielectric solution 163. For example, an example of the material forming the transparent film 271 may include polyethylene terephthalate (PET), polyethylene naphthalate (PEN), polyether sulfone (PES), or the like.

The second electrode 150 may be disposed on the lower part of the transparent film 271. In this case, the second electrode 150 may have a thinner thickness than that of the transparent film 271. For example, the transparent film 271 may have a thickness of several tens to several hundreds μm. On the other hand, the conductive layer forming the second electrode 150 may have a thickness of several tens to several μm. Therefore, the second electrode 150 may have the convex portion 151 corresponding to the convex portion 272 of the transparent film 271.

The convex portion 272 of the transparent film 271 may be disposed corresponding to the cell region 131. Therefore, when viewing the twist ball 160 through the convex portion 272, the image of the twist ball 160 may look like being completely filled in the cell region 131. Therefore, since peripheral space to rotate the twist ball 160, that is, the dead zone is visually reduced, the contrast ratio and reflectivity of the electronic paper display device 100 can be simultaneously improved. As a result, the overall image quality characteristics of the electronic paper display device 100 can be improved due to the improvement of contrast ratio and reflectivity of the electronic paper display device 100.

In addition, the enlarging member 270 to visually enlarge the size of the twist ball 160 may also serve as the second electrode 150 and the base layer, such that the entire thickness of the electronic paper display device 100 can be reduced.

The exemplary embodiment of the present invention describes the case where the second electrode 150 and the transparent film 271 are formed in a double structure but is not limited thereto. For example, when the transparent film 271 is made of conductive polymer or resin including conductive powder, the transparent film 271 may serve as the second electrode 150. That is, the transparent film 271 may be integrally formed with the second electrode 150.

Therefore, as in the exemplary embodiment of the present invention, the enlarging member may be formed by changing the shape of the second electrode and the base layer due to the overfilling of the dielectric solution, such that the thickness of the electronic paper display device can be minimized, the contrast ratio and reflectivity of the electronic paper display device can be improved, and the image quality characteristics of the electronic paper display device can be improved.

Hereinafter, the second exemplary embodiment of the present invention describes the case where the second electrode is formed on the lower part of the transparent film or is integrally formed with the transparent film, but the second electrode may be provided in another type.

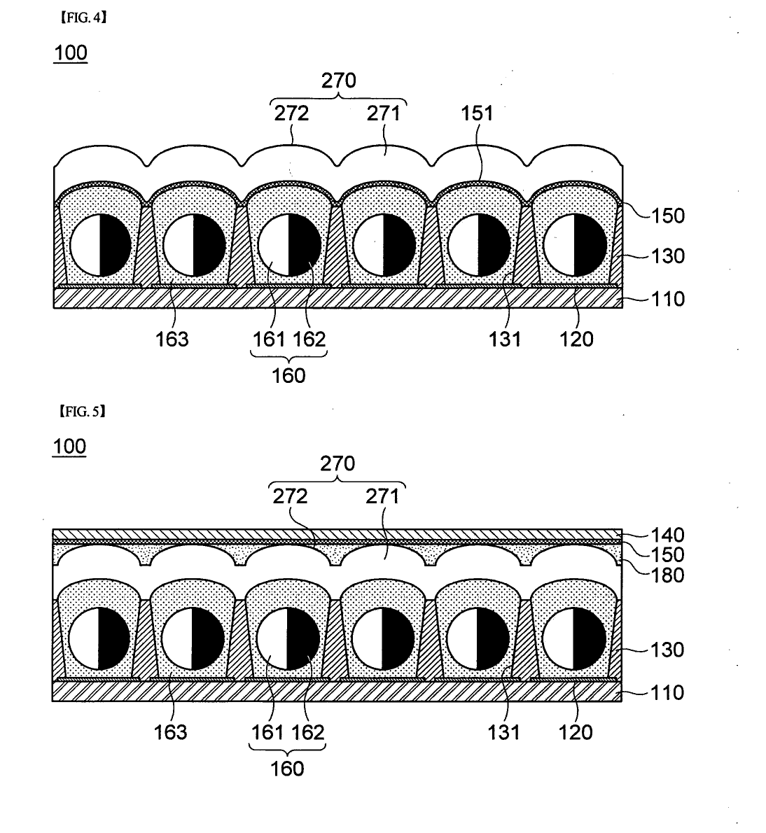

Hereinafter, referring to FIG. 5, an example of another type of the second electrode included in the electronic paper display device according to the second exemplary embodiment of the present invention will be described in more detail. In this case, the electronic paper display device has the same technical components as the above-mentioned electronic paper display device except for the type of the second electrode and therefore, the description thereof is not repeated. Like components are denoted by like reference numerals.

FIG. 5 is a cross-sectional view of an electronic paper display device shown for explaining an example of other types of a second electrode included in an electronic paper display device according to a second exemplary embodiment of the present invention.

In this case, the electronic paper display device has the same technical components as the electronic paper display device according to the second exemplary embodiment except for the configuration of the second electrode and therefore, the description thereof is not repeated. Like components are denoted by like reference numerals.

As shown in FIG. 5, the second electrode 150 may be disposed on the transparent film 271 including the convex portion 272 corresponding to the cell region 131 due to the overfilling of the dielectric solution 163.

In this case, the second electrode 150 may be fixed through an adhesive member 180 applied on the transparent film 271.

The adhesive member 180 may be made of a transparent adhesive resin that can transmit light. In the case, an example of the transparent adhesive resin may include, for example, any one or at least two of silicon resin, acryl-based resin, and epoxy-based resin.

The adhesive member 180 is disposed on the transparent film 271 as one layer, but is not limited thereto. In this case, the adhesive member 180 may be formed in a predetermined region of the transparent film, for example, on the region corresponding to the barrier layer 130 in a pattern.

Further, the second electrode 150 may be disposed on the lower part of the second base layer 140. The second base layer 140 may have the substrate type or the film type. In addition, the second base layer 140 may be made of the transparent material that can transmit light. For example, the second base layer 140 may include polyethylene terephthalate (PET), polyvinyl alcohol (PVA), polyethylene (PE), polycarbonate (PC), polyacrylate, polymethylacrylate, polyurethane, cellulose acetate butylate (CAB), or the like.

Therefore, as in the exemplary embodiment of the present invention, the flat second electrode is bonded to the transparent film including the convex portion by using the transparent adhesive member to visually enlarge the size of the twist ball, such that the contrast ratio and reflectivity of the electronic paper display device can be improved and the image quality characteristics of the electronic paper display device can be improved while having the flat surface.

FIG. 6 is a cross-sectional view of an electronic paper display device according to a third exemplary embodiment of the present invention.

In this case, the electronic paper display device has the same technical components as the electronic paper display device according to the second exemplary embodiment except for the configuration of the enlarging member and therefore, the description thereof is not repeated. Like components are denoted by like reference numerals.

Referring to FIG. 6, the electronic paper display device 100 according to the second exemplary embodiment of the present invention may include the first electrode 120, the barrier rib layer 130 defining a plurality of cell regions on the first electrode 120, the second electrode 150 disposed on the barrier rib layer 130, facing the first electrode 120, the twist ball 160 floating in the dielectric solution filled in each cell region 131 and displaying images according to electric field applied to the first and second electrodes 120 and 150, and the enlarging member 270 visually enlarging the size of the twist ball 160.

In this configuration, the enlarging member 270 may include the polymer gel 190 of which volume is convexly expanded corresponding to the cell region 131, and the transparent film 271 including the convex portion 272 by the polymer gel 190.

The polymer gel 190 is filled in each cell region 131. In this case, the volume of the polymer gel 190 may be expanded upward, corresponding to the cell region 131 by the dielectric solution 163 impregnated within the polymer gel 190.

The volume of the polymer gel 190 may be expanded due to the impregnation of the dielectric solution 163 and may be made of the light transmitting polymer that can transmit light. An example of the material forming the polymer gel 190 may include polydimethylsiloxane (PDMS), polyethylene (PE), polytetrafluoroethylene (PTFE), or the like.

The second electrode 150 is disposed on the lower part of the transparent film 271 and may have the convex portion 151 corresponding to the convex portion 272. However, the exemplary embodiment of the present invention describes the case where the second electrode 150 and the transparent film 271 are formed in a double structure stacked one on another, but is not limited thereto. For example, when the transparent film 271 is made of conductive polymer or resin including conductive powder, the transparent film 271 may serve as the second electrode. That is, the transparent film may be integrally formed with the second electrode. Alternatively, the second electrode 150 may be attached to the transparent film 271 including the convex portion 272 by using the transparent adhesive member. In this case, the second base layer may be further disposed on the second electrode 150.

Therefore, as in the exemplary embodiment of the present invention, the enlarging member capable of visually enlarging the size of the twist ball can be easily formed by the polymer gel of which volume can be expanded by the dielectric solution.

Further, the polymer gel serves to support the transparent film to prevent the transparent film from being easily deformed and to buffer the impact, thereby making it possible to secure the durability of the electronic paper display device.

Hereinafter, a method for manufacturing an electronic paper display device according to an embodiment of the present invention will be described in detail with reference to FIGS. 7 to 17.

FIGS. 7 to 11 are cross-sectional views for explaining a method for manufacturing an electronic paper display device according to a fourth exemplary embodiment of the present invention.

Referring to FIG. 7, in order to manufacture the electronic paper display device according to the fourth exemplary embodiment of the present invention, the first electrode 120 is formed on the first base layer 110.

In this case, an example of the material forming the first base layer 110 may be a plastic substrate, a glass substrate, etc., or a film type.

In order to form the first electrode 120, the conductive layer is first formed on the first base layer 110. The material of the conductive layer may be Cu, Ag, etc. The conductive layer may be patterned by a patterning process using a photolithography. That is, the first electrode 120 may be formed in a plurality of conductive patterns.

The exemplary embodiment of the present invention describes the case where the first electrode 120 is formed by the patterning process, but is not limited thereto. For example, the first electrode 120 may be formed by an inkjet printing method selectively applying conductive paste and a deposition process using a mask.

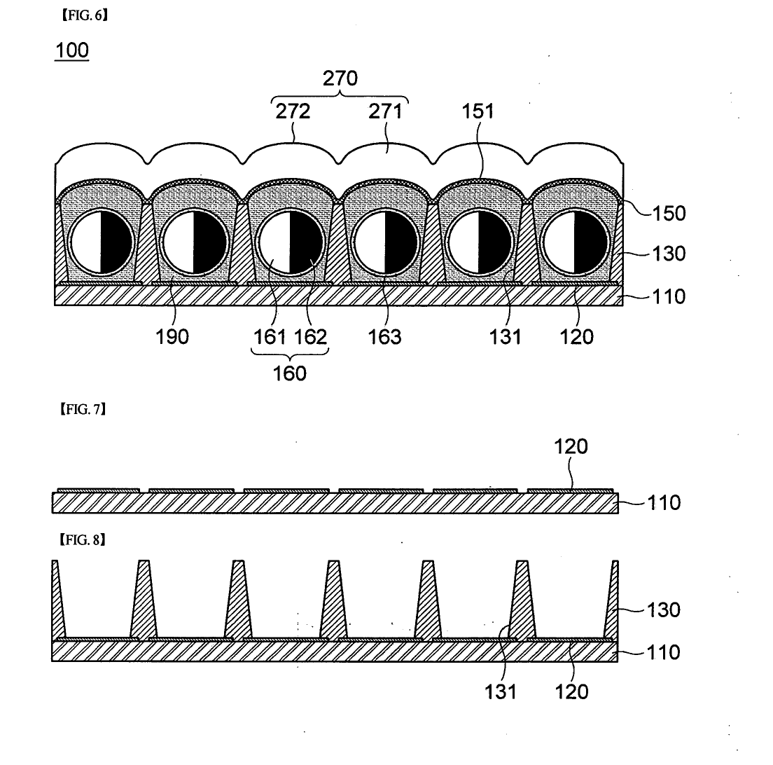

Referring to FIG. 8, after the first electrode 120 is formed, the barrier rib 130 defining the plurality of cell regions 131 is formed on the first electrode 120.

The barrier rib layer 130 may be formed by forming a curable resin layer on the first base layer 110 including the first electrode 120 and then, performing exposure and developing processes thereon. In this case, the curable resin may be a thermosetting resin or an UV curable resin. For example, the barrier rib layer 130 may be made of polyurethane acrylate (PUA) or polydimethylsiloxane (PDMS), but the material of the curable resin of the present invention is not limited thereto.

In this case, an example of another method for forming the barrier rib 130 may include an inkjet printing method, an imprinting method, or the like, but the method for forming the barrier rib layer 130 of the exemplary embodiment of the present invention is not limited thereto.

Referring to FIG. 9, after the barrier rib layer 130 is formed, the twist ball 160 is injected into each cell region 131.

For example, the method for injecting the twist ball 160 disposes a filter having the openings corresponding to each cell region 131 on the barrier rib layer 130 and then, loads the twist ball 160 on the filter. Thereafter, vibrations are applied to the filter and the first electrode 120 including the barrier rib layer 130, such that the twist ball 160 may be selectively injected into each cell region 131.

After the twist ball 160 is injected into each cell region 131, the second electrode 150 is formed on the barrier rib layer 130 including the twist ball 160.

In order to form the second electrode 150, the conductive material that can transmit light is deposited on the second base layer 140 to form the second electrode 150. In this case, an example of the conductive material may be ITO, IZO, ITZO, or the like.

Thereafter, the second base layer 140 including the second electrode 150 is bonded to the barrier rib layer 130 so that the first electrode and the second electrode 120 and 150 face each other. In this case, after the adhesive layer is formed on the barrier rib layer 130 or the second electrode 150, the bonding of the second base layer 140 may be made by the bonding of the barrier rib layer 130 and the second electrode 150 through the adhesive layer.

The exemplary embodiment of the present invention describes the case where the second electrode 150 has the second base layer 140 formed on the upper part thereof but the second electrode 150 may be formed of the conductive substrate. In other words, the second electrode 150 may serve as the electrode and the substrate.

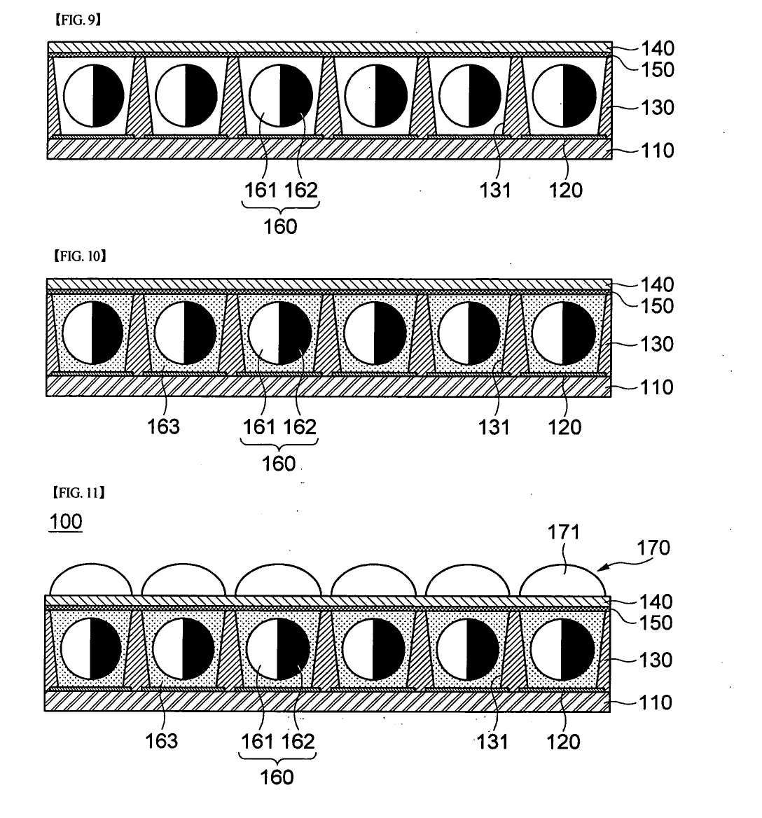

Referring to FIG. 10, after the second electrode 150 is formed, the dielectric solution 163 is injected into each cell region 131. The first and second base layers 110 and 140 bonded to each other are dipped in the dielectric solution in order to inject the dielectric solution 163. In this case, the dielectric solution 163 may be injected into each cell region through a porous included in the barrier rib layer 130. In this case, a liquid-phase material performing liquid-phase photo conversion and having lubricant component, for example, Dow corning 10, Centistoke 200, or the like, may be used as the dielectric solution 163.

Referring to FIG. 11, the enlarging member 170 to visually enlarge the twist ball 160 is formed on the second base layer 140. In this case, the enlarging member 170 may include any one of the convex lens 171 and the prism lens.

In order to form the enlarging member 170, hydrophobic surface treatment is first performed on the corresponding second electrode 150 corresponding to the cell region 131. As an example of the hydrophobic surface treatment, a fluoride plasma or a resin pattern having a hydrophobic functional group may be used.

Thereafter, hydrophilic resin composition is applied to the second electrode 150. In this case, the hydrophilic resin composition may include silicon resin. In this case, the hydrophilic resin composition may be aggregated based on the cell region by hydrophobic property. At the same time, the enlarging member 270 can convexly be deformed in the cell region by the surface tension of the hydrophobic resin composition. Thereafter, the enlarge member 170 including the convex lens 171 may be formed on the second electrode 150 by curing the convexly deformed hydrophilic resin composition.

As the example of another method for forming the expanding member 170, the expanding member 170 may be formed by a method of applying the adhesive to the second electrode 150 and then, attaching the expanding member sheet including any one of the convex lens 171 and the prism lens by using the adhesive, a printing method printing any one shape of the convex lens 171 and the prism lens on the second electrode 150, or an imprinting method using a molding having any one shape of the convex lens 171 and the prism lens.

Therefore, as in the exemplary embodiment of the present invention, the contrast ratio and reflectivity of the electronic paper display device can be improved by forming the enlarging member to visually enlarge the twist ball, thereby making it possible to manufacture the electronic paper display device having the excellent image quality characteristics.

FIGS. 12 to 14 are cross-sectional views for explaining a method for manufacturing an electronic paper display device according to a fifth exemplary embodiment of the present invention. In this case, the same method as the method for manufacturing the electronic paper display device according to the above-mentioned fourth exemplary embodiment can be applied except for the method for forming the enlarging member and therefore, the repeated description with the fourth exemplary embodiment will be omitted. The same technical components as the fourth exemplary embodiment are denoted by like reference numerals.

Referring to FIG. 12, in order to manufacture the electronic paper display device according to the fifth exemplary embodiment, the barrier rib layer 130 defining the plurality of cell regions 131′ is first formed on the first electrode 120.

In this case, the first base layer 110 may further be disposed on the lower part of the first electrode 120.

Referring to FIG. 13, after the barrier rib layer 130 is formed, the twist ball 160 is injected into the corresponding first electrode 120 corresponding to each cell region 131.

After the twist ball 160 is injected, the second electrode 150 and the transparent film 271 are formed on the barrier rib layer 130 including the twist ball 160. In this case, in order to form the second electrode 150 and the transparent film 271, the second electrode 150 is first formed on the transparent film 271. Thereafter, the transparent film 271 formed with the second electrode 150 is attached to the barrier rib layer 130 by using the transparent adhesive.

In this case, the transparent film 271 may be made of the flexible material to be easily deformed. For example, an example of the material forming the transparent film 271 may include polyethylene terephthalate (PET), polyethylene naphthalate (PEN), polyether sulfone (PES), or the like

Further, the second electrode 150 may have a thinner thickness than that of the transparent film 271. For example, the transparent film 271 may have a thickness of several tens to several hundreds μm. On the other hand, the conductive layer forming the second electrode 150 may have a thickness of several tens to several μm.

The exemplary embodiment of the present invention describes the case where the second electrode 150 and the transparent film 271 are formed in a double structure where they are sequentially stacked but is not limited thereto. For example, when the transparent film 271 is made of conductive polymer or resin including conductive powder, the transparent film 271 may serve as the second electrode 150. That is, the transparent film 271 may be integrally formed with the second electrode 150.

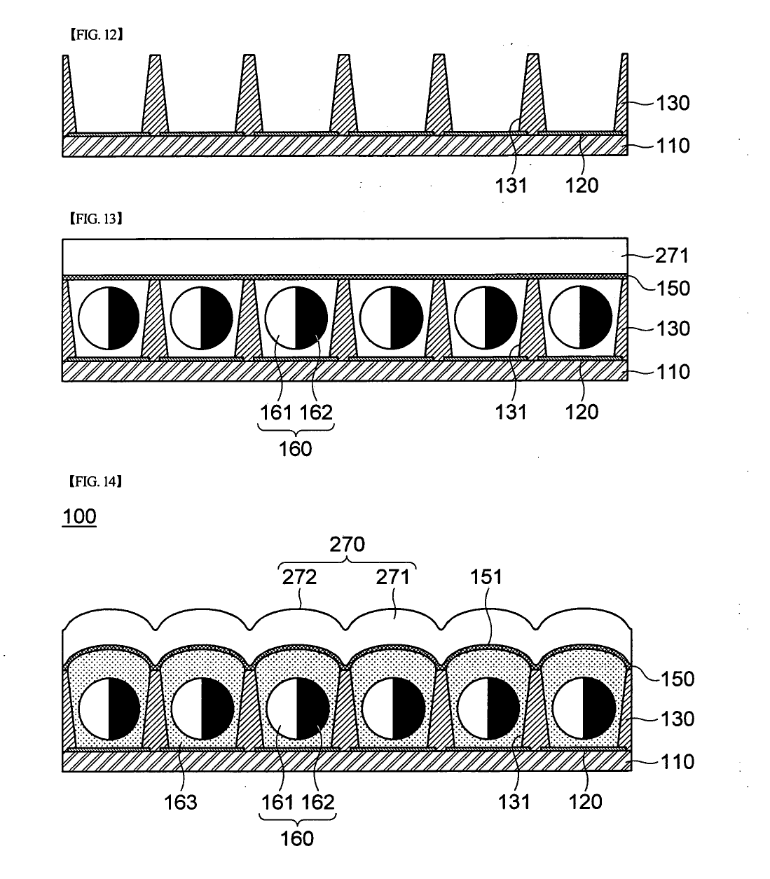

Referring to FIG. 14, after the second electrode 150 and the transparent film 271 are formed, the convex portions 272 corresponding to each cell region 131 are formed on the transparent film 271 by overfilling the dielectric solution 163 in each cell region 131, thereby making it possible to form the enlarging member 270 capable of visually enlarging the images of the twist ball 160.

In this case, when the dielectric solution 163 is overfilled in the space of each cell region 131, the transparent film 271 has flexibility, such that it is convexly deformed by the pressure of the dielectric solution 163 overfilled in the cell region 131, thereby making it possible to form the convex portion 272. In this case, the overfilling of the dielectric solution 163 may be made under the atmosphere of a higher atmospheric pressure than an air pressure.

The second electrode 150 disposed on the lower part of the transparent film 271 may also be convexly deformed during a process of deforming the transparent film 271. Since the thickness of the second electrode 150 has a very thin thickness as compared to the transparent film 271, it may have flexibility, such that the second electrode 150 can be convexly deformed. That is, the second electrode 150 is may include the convex portion 151 corresponding to the convex portion 272 formed on the transparent film 271.

The convex portion 272 is formed to correspond to the cell region 131 and thus, the image of the twist ball 160 may look like being visually enlarged when viewing the twist ball through the convex portion 272.

The exemplary embodiment of the present invention describes the case where the second electrode 150 is formed on the lower part of the transparent film 271 and the corresponding convex portion 151 is formed on the second electrode 150, but is not limited thereto. For example, after the convex portion 272 is formed on the transparent film 271 by overfilling the dielectric solution 163, the adhesive member may be formed on the transparent film 271 including the convex portion 272 and the second electrode 150 may be attached to the transparent film 271 by the adhesive member. In this case, the second electrode may be formed of the conductive substrate or the second base layer may be further provided on the upper part thereof.

Therefore, the exemplary embodiment of the present invention can easily form the enlarging member by overfilling the dielectric solution, thereby making it possible to easily form the electronic paper display device having the excellent image quality characteristics.

In addition, the twist ball can be visually enlarged through the deformation of the base layer and the second electrode rather than attaching the separate enlarging member, thereby making it possible to reduce the manufacturing cost as well as the thickness of the electronic paper display device.

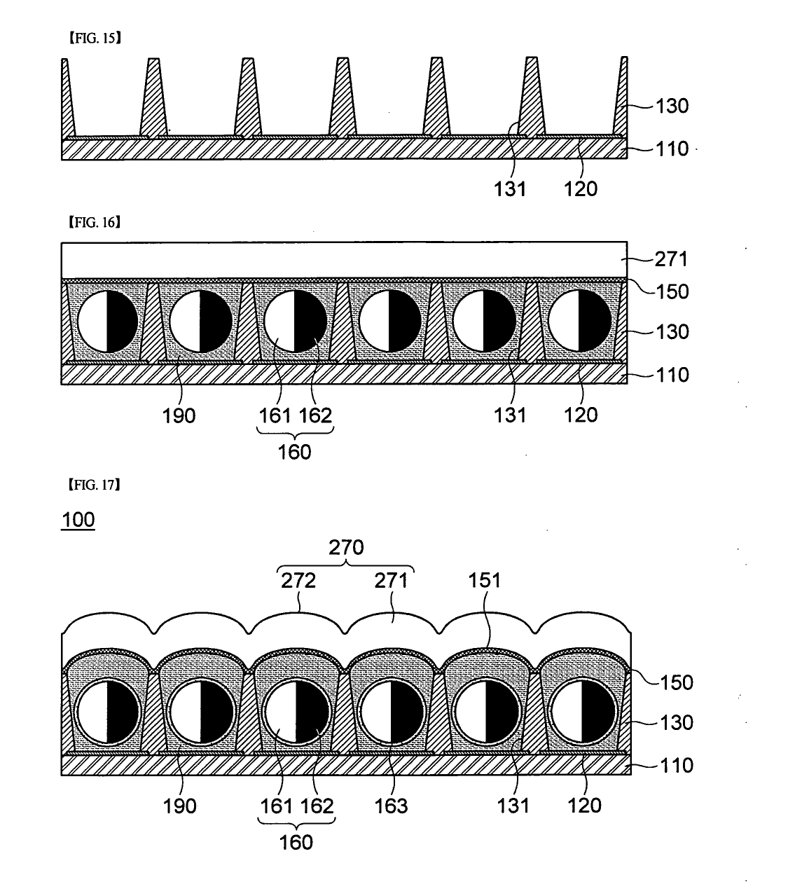

FIGS. 15 to 17 are cross-sectional views for explaining a method for manufacturing an electronic paper display device according to a sixth exemplary embodiment of the present invention. In this case, the same method as the method for manufacturing the electronic paper display device according to the above-mentioned fifth exemplary embodiment can be applied except for the method for forming the enlarging member and therefore, the repeated description with the fifth exemplary embodiment will be omitted. The same technical components as the fifth exemplary embodiment are denoted by like reference numerals.

Referring to FIG. 15, in order to manufacture the electronic paper display device according to the sixth exemplary embodiment, the barrier rib layer 130 defining the plurality of cell regions 131 is first formed on the first electrode 120. In this case, the first base layer 110 may further be disposed on the lower part of the first electrode 120.

Referring to FIG. 16, after the barrier rib layer 130 is formed, the twist ball 160 is injected into the corresponding first electrode 120 corresponding to each cell region 131.

After the twist ball 160 is injected, the polymer gel 190 of which volume can be expanded by the dielectric solution 163 to be described below is filled in each cell region 131.

In this case, the polymer gel 190 may made of a material that can transmit light. In this case, an example of the material forming the polymer gel 190 may include polydimethylsiloxane (PDMS), polyethylene (PE), polytetrafluoroethylene (PTFE), or the like. In addition, the filling of the polymer gel 190 may be performed by a dispensing method, an inkjet printing method, or the like.

After the polymer gel 190 is filled, the second electrode 150 and the transparent film 271 are formed on the barrier rib layer 130 including the twist ball 160.

In this case, the transparent film 271 may be made of the flexible material to be easily deformed. In this case, the second electrode 150 may have a thinner thickness than that of the transparent film 271.

The exemplary embodiment of the present invention describes the case where the second electrode 150 and the transparent film 271 are formed in a double structure where they are sequentially stacked but is not limited thereto. For example, when the transparent film 271 is made of conductive polymer or resin including conductive powder, the transparent film 271 may be integrally formed with the second electrode.

Referring to FIG. 17, after the electrode 150 and the transparent film 271 are formed, the dielectric solution 163 is injected into each cell region 131.

In this case, the volume of the polymer gel 190 filled in each cell region 131 can be expanded upward by the dielectric solution 163. In this case, the transparent film 271 has flexibility, such that the convex portion 272 convexly deformed by the polymer gel 190 convexly expanded corresponding to the cell region 131 is formed on the transparent film 271, thereby making it possible to form the enlarging member 270 visually enlarging the images of the twist ball 160.

In this case, the corresponding convex portion 151 convexly deformed may be formed on the second electrode 150 disposed on the lower part of the transparent film 271 during the process of deforming the transparent film 271.

Therefore, the convex portion 272 is formed to correspond to each cell region 131 and the image of the twist ball 160 may look like being visually enlarged when viewing the twist ball through the convex portion 272.

The exemplary embodiment of the present invention describes the case where the second electrode 150 is formed on the lower part of the transparent film 271 and the corresponding convex portion 151 is formed on the second electrode 150, but is not limited thereto. For example, after the convex portion 272 is formed on the transparent film 271 by expanding the volume of the polymer gel 190, the adhesive member may be formed on the transparent film 271 including the convex portion 272 and the second electrode 150 may be attached to the transparent film 271 by the adhesive member. In this case, the second electrode 150 may be formed of the conductive substrate or the second base layer may be further provided on the upper part thereof.

Therefore, the exemplary embodiment of the present invention can easily form the enlarging member by using the polymer gel of which volume can be expanded by the dielectric solution, thereby making it possible to easily form the electronic paper display device having the excellent image quality characteristics.

The electronic paper display device according to the present invention has the enlarging member visually enlarging the size of the twist ball to fill the dead zone with the images of the twist ball, thereby making it possible to improve the contrast ratio and reflectivity of the electronic paper display device.

In addition, the overall mage quality characteristics can be improved due to the improved contrast ratio and reflectivity of the electronic paper display device.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic paper display device, comprising:
a first electrode;
a barrier rib layer disposed on the first electrode and defining a plurality of cell regions;
a second electrode facing the first electrode and disposed on the barrier rib layer;
a twist ball floated in a dielectric solution filled in each cell region and driven according to electric field applied to the first and second electrodes; and
an enlarging member disposed on any one of the top surface and the bottom surface of the second electrode and visually enlarging the size of the twist ball.

2. The electronic paper display device according to claim 1, wherein the enlarging member includes any one of a convex lens and a prism lens.

3. The electronic paper display device according to claim 1, wherein the enlarging member includes a transparent film including a convex portion corresponding to the cell region.

4. The electronic paper display device according to claim 3, wherein the convex portion is formed by a polymer gel of which volume is expanded upward due to the dielectric solution highly filled in the cell region or the impregnation of the dielectric solution.

5. The electronic paper display device according to claim 3, wherein the second electrode includes a convex portion corresponding to the convex portion.

6. The electronic paper display device according to claim 3, wherein the second electrode is disposed on the lower part of the transparent film.

7. The electronic paper display device according to claim 3, further comprising an adhesive member interposed between the second electrode and the enlarging member.

8. The electronic paper display device according to claim 3, wherein the second electrode is integrally formed with the transparent film.

9. A method for manufacturing an electronic paper display device, comprising:
forming a barrier rib layer defining a plurality of cell regions on a first electrode;
injecting a twist ball into the first electrode in each cell region;
forming a second electrode on the barrier rib layer including the twist ball;
injecting a dielectric solution into each cell around the twist ball; and
forming enlarging member visually enlarging the twist ball on the second electrode.

10. The method for manufacturing an electronic paper display device according to claim 9, wherein the enlarging member includes any one of a convex lens and a prism lens.

11. The method for manufacturing an electronic paper display device according to claim 9, wherein the forming the enlarging member includes:
performing hydrophobic surface treatment on the second electrode corresponding to the periphery of the cell region;
applying hydrophilic resin composition to the second electrode; and
curing the applied hydrophilic composition after the applied hydrophilic resin composition is naturally convexly deformed.

12. The method for manufacturing an electronic paper display device according to claim 9, wherein the forming the enlarging member includes:
applying an adhesive to the second electrode; and
attaching an enlarging member sheet to the second electrode by using the adhesive.

13. The method for manufacturing an electronic paper display device according to claim 9, wherein the enlarging member is formed by any one of a printing method and an imprinting method.

14. A method for manufacturing an electronic paper display device, comprising:
forming a barrier rib layer defining a plurality of cell regions on a first electrode:
injecting a twist ball into the first electrode in each cell region;
forming a transparent film and a second electrode on the barrier rib layer including the twist ball; and
forming a convex portion visually enlarging the twist ball corresponding to each cell region in the transparent film by overfilling a dielectric solution in each cell around the twist ball.

15. The method for manufacturing an electronic paper display device according to claim 14, wherein the second electrode is disposed on the lower part of the transparent film to form a convex portion corresponding to the convex portion in the second electrode.

16. The method for manufacturing an electronic paper display device according to claim 14, wherein the transparent film is integrally formed with the second electrode.

17. The method for manufacturing an electronic paper display device according to claim 14, wherein the second electrode is attached to the transparent film by an adhesive member.

18. The method for manufacturing an electronic paper display device according to claim 17, wherein the second electrode is formed of a conductive substrate.

19. The method for manufacturing an electronic paper display device according to claim 17, further comprising forming a base layer on the second electrode.

20. A method for manufacturing an electronic paper display device, comprising:
forming a barrier rib layer defining a plurality of cell regions on a first electrode;
injecting a twist ball into the first electrode in each cell region;
filling a polymer gel in a cell region of the barrier rib layer including the twist ball;
forming a transparent film and a second electrode on the barrier rib layer including the polymer gel; and
forming a convex portion visually enlarging the twist ball corresponding to each cell region in the transparent film due to the expansion of the polymer gel by filling a dielectric solution in each cell region around the twist ball.

21. The method for manufacturing an electronic paper display device according to claim 20, wherein the second electrode is disposed on the lower part of the transparent film to form a convex portion corresponding to the convex portion in the second electrode.

22. The method for manufacturing an electronic paper display device according to claim 20, wherein the transparent film is integrally formed with the second electrode.

23. The method for manufacturing an electronic paper display device according to claim 20, wherein the second electrode is attached by an adhesive member formed on the transparent film.

24. The method for manufacturing an electronic paper display device according to claim 23, wherein the second electrode is formed of a conductive substrate.

25. The method for manufacturing an electronic paper display device according to claim 23, further comprising forming a base layer on the second electrode.
